(19) United States
(12) Patent Application Publication
(10) Pub. No.: US 2016/0375978 A1
(43) Pub. Date: Dec. 29, 2016

(54) Stiffened fuselage component as well as method and apparatus for manufacturing a stiffened fuselage component

(71) Applicant: Airbus Operations GmbH, Hamburg (DE)

(72) Inventor: Paul Joern, Hamburg (DE)

(21) Appl. No.: 15/190,982

(22) Filed: Jun. 23, 2016

(30) Foreign Application Priority Data
Jun. 24, 2015 (EP) 15173538.8

(51) Int. Cl. B64C 1/06; B29D 99/00; B29C 65/60; B64C 1/12; B29B 11/06

(52) U.S. Cl. CPC B64C 1/068; B64C 1/12; B29B 11/06; B29C 65/601; B29D 99/0021; B64C 2001/0072

(57) ABSTRACT

A stiffened fuselage component made of a fiber reinforced composite material, in particular for use in an aircraft, comprises a skin element and a plurality of elongated stiffening elements forming a stiffening element pattern comprising a plurality of node points and being attached to an inner surface of the skin element. At least some of the node points are defined by an intersection of at least two stiffening elements at an acute angle or an obtuse angle. At least some of the elongated stiffening elements are shaped so as to define an internal cavity delimited by an inner surface of the stiffening elements and covered by the skin element.

### CROSS-REFERENCES TO RELATED APPLICATIONS

This application claims the benefit of the European patent application No. 15 173 538.8 filed on Jun. 24, 2015, the entire disclosures of which are incorporated herein by way of reference.

### BACKGROUND OF THE INVENTION

The invention relates to a stiffened fuselage component, in particular a stiffened aircraft fuselage component. Furthermore, the invention relates to a method and an apparatus for manufacturing a stiffened fuselage component.

In aircraft construction, efforts are being made increasingly to use, as load-bearing components, components that are made entirely or partially of fiber reinforced composite materials, for example carbon fiber reinforced plastics (CFRP). For example, DE 10 2007 062 111 A1 describes a crosspiece structure made of carbon fiber reinforced plastics material that is used to support the individual panels of an aircraft floor system for separating a passenger cabin from a cargo area disposed underneath the passenger cabin. It is further known for example from DE 10 2004 001 078 A1 and CN 100418850 to provide aircraft fuselage segments with a skin and reinforcing elements (for example frames, stringers) made of fiber reinforced composite materials.

When manufacturing aircraft structural components from fiber reinforced composite materials, in first step, a multi-layer laminate may be constructed from reinforcing fibers or fiber prepregs. The fiber prepregs may comprise a woven or non-woven fabric made of reinforcing fibers, which is provided with a surface layer of a curable synthetic material, for example an epoxy resin material. The laminate construction may be effected manually or in an automated manner. The reinforcing fibers or fiber prepregs may then be brought into a desired shape of a planar portion intended to form an aircraft skin or of a stiffening portion intended to form a frame or stringer, before a curable material may be injected into the laminate construction. Finally, the injected curable material and/or the curable material applied onto the surfaces of the fibers may be cured under pressure and/or raised temperature, for example in an autoclave cycle, thereby producing a composite material having a matrix of a cured synthetic material and reinforcing fibers embedded in the matrix.

EP 2 674 290 A1 and US 2013/337207 A1 concern a method for manufacturing a fuselage barrel or a shell component of an aircraft from a fiber reinforced plastic material. The fuselage barrel or shell component comprises a plurality of monolithic stiffening ribs crossing one another node points and a skin attached to the stiffening ribs. A molding tool for manufacturing the fuselage barrel or shell component has a plurality of channel type depressions for creating the monolithic stiffening ribs. At least one depression is designed in the form of a groove with two sidewalls attached on both sides to a base surface. A groove edge zone for the formation of integral connecting feet for the skin is attached to at least one sidewall in at least some sections.

EP 2 662 202 A2 and US 2013/302544 A1 disclose a method for manufacturing a reinforcement section of a fiber composite component, wherein a supporting core with an elastic sleeve is temporarily arranged on an inner surface of a fibrous material intended to form the reinforcement section. A curable material may be present in the fibrous material or may be injected into the fibrous material. Upon curing the curable material under a reduced pressure, the sleeve of the supporting core is drawn against the inner surface of the fibrous material so as to exert a pressure thereupon.

### SUMMARY OF THE INVENTION

The invention is directed to an object of providing a weight-optimized stiffened fuselage component which is particularly suitable for use in an aircraft. Furthermore, the invention is directed to an object of providing a method and an apparatus for efficiently manufacturing a stiffened fuselage component of this kind.

A stiffened fuselage component which is particularly suitable for use in an aircraft is made of a fiber reinforced composite material. Different fiber reinforced composite materials may be used for manufacturing the stiffened fuselage component. As reinforcing fibers, for example carbon fibers, but also other reinforcing fibers may be employed. The reinforcing fibers may be embedded in a matrix of a curable thermoset material, such as, for example, a resin material, in particular, an epoxy resin. Alternatively, also a thermoplastic material, for example, polyether ether ketone (PEEK) may be used for forming the matrix of the fiber reinforced composite material. The stiffened fuselage component may be designed so as to define a section of an aircraft fuselage. The component may extend along only a part of the circumference of the aircraft fuselage or may extend along the entire circumference of the aircraft fuselage.

The stiffened fuselage component comprises a skin element. The skin element may be designed in the form of planar element, but preferably is provided with a curved shape which is adapted to a curvature of a fuselage section, in particular an aircraft fuselage section, the fuselage component is intended to form. Preferably, the skin element is designed in the form of a monolithic element. If desired, additional functional layers such as reinforcing layers or the like may be integrated into the skin element. The skin element may comprise an outer surface which, in case the fuselage component is designed in the form of an aircraft fuselage component, may be suitable to form a section of the aircraft's outer skin. Furthermore, the skin element may comprise an inner surface which, in case of the fuselage component is designed in the form of an aircraft fuselage component, may be suitable to face an interior of the aircraft fuselage.

The stiffened fuselage component further comprises a plurality of elongated stiffening elements forming a stiffening element pattern comprising a plurality of node points and being attached to the inner surface of the skin element. The skin element and the stiffening elements preferably are made of the same fiber reinforced composite material. It is, however, also conceivable to use different fiber reinforced composite materials for the skin element and the stiffening elements.

At least some of the node points are defined by an intersection of at least two stiffening elements at an acute angle or an obtuse angle. The fuselage component thus differs for example from prior art aircraft fuselage components, wherein ribs (extending around the circumference of the fuselage) and stringers (extending parallel to a longitudinal axis of the fuselage) always intersect with each other at right angles, in the arrangement of the elongated stiffening elements relative to each other at the node points. By deviating from the prior art arrangement of the stiffening elements, both the weight and the load bearing capacity of the fuselage component can be adapted as needed to specific requirements. Furthermore, in the fuselage component, different designs for ribs and stringers as well as an integration of ribs into a pre-manufactured skin/stringer structure are no longer necessary.

The arrangement of the stiffening elements relative to each other may be the same at different node points or may vary from node point to node point, i.e., for example, at some node points the stiffening elements may intersect at a specific first acute angle, whereas at other node points the stiffening elements may intersect at a specific second acute angle or at an obtuse angle. Furthermore, some or all node points may be defined by the intersection of only two stiffening elements or some or all node points may be defined by the intersection of more than two, for example three or more stiffening elements.

At least some of the elongated stiffening elements of the fuselage component are shaped so as to define an internal cavity delimited by an inner surface of the stiffening elements and covered by the skin element. As compared to fuselage components which are equipped with monolithic stiffening elements, the stiffened fuselage component thus distinguishes by a low weight. The stiffening elements may, for example, be designed in the form of omega stiffeners which, due to their size and shape, allow an advantageous distribution of the reinforcing fibers within the composite material used for making the stiffening elements. At the node points of the stiffening element pattern, omega stiffeners may define a so-called “star-like omega hat,” i.e., a star pattern with a continuous internal hollow space which is defined by the internal cavities of the stiffening elements meeting at the node points of the stiffening element pattern. It is, however, also conceivable to provide the fuselage component with stiffening elements having other cross sectional shapes than an omega-shaped cross-sectional shape, for example, a more rounded cross-section or the like.

The stiffening element pattern defined by elongated stiffening elements of the fuselage component preferably is an irregular pattern, wherein distances between individual stiffening elements and/or node points varies. Furthermore, within the stiffening element pattern, the design of the node points, in terms of the number and the angular arrangement of the stiffening elements intersecting each other at the node points, may vary. In a particularly preferred embodiment of the fuselage component, the distribution of the stiffening elements in the stiffening element pattern is adjusted in dependence on load bearing requirements defined for different regions of the stiffened fuselage component. For example, regions of the fuselage component which face higher load bearing requirements may be provided with more stiffening elements than regions of the fuselage component which face lower load bearing requirements.

At least some of the plurality of elongated stiffening elements may differ from each other, for example in at least one of length, cross sectional shape and cross-sectional area. Alternatively, or additionally thereto, at least some of the plurality of elongated stiffening elements, along a longitudinal axis thereof, may be provided with at least one of a varying cross sectional shape and a varying cross-sectional area. Moreover, it is also conceivable that at least some of the plurality of elongated stiffening elements, along a longitudinal axis thereof, are curved with a constant or varying curvature. The stiffening elements may be curved so as to extend parallel to a curved skin element. Alternatively, or additionally thereto, the stiffening elements, however, may also be curved relative to a plane defined by the (curved) skin element. A fuselage component which is provided with varying stiffening elements may be optimized in terms of both weight and load bearing capability, since regions of the fuselage component which face higher load bearing requirements can easily be provided with stronger and suitably shaped, but heavier stiffening elements than regions of the fuselage component which face lower load bearing requirements.

In one embodiment of the stiffened fuselage component, at least some of the plurality of elongated stiffening elements comprise a foam core arranged in the internal cavity delimited by the inner surface of the stiffening elements and covered by the skin element. The foam core may, for example, be a CNC-milled foam core and may be designed as a load bearing component or non-load bearing component, as desired.

At least some of the plurality of elongated stiffening elements may be connected to each other by an internal skin element extending substantially parallel to and being attached to the skin element. The fuselage component then is particularly easy to manufacture, since plural stiffening elements, together with the internal skin element, can be joined to the skin element in a single manufacturing step. The internal skin element may be of a continuous design and hence may extend across the internal cavities of the stiffening elements adjacent to the skin element. It is, however, also conceivable that the internal skin element merely extends between adjacent stiffening elements, so that the internal cavities of the stiffening elements are only covered by the skin element. Finally, it is also possible that the internal skin element extends across only a part, in particular an edge portion of the internal cavities of the stiffening elements adjacent to the skin element.

In a particularly preferred embodiment of the stiffened fuselage component, a functional element such as, for example, at least one of an electric line and a fluid line may be arranged in the internal cavity delimited by the inner surface of the stiffening elements and covered by the skin element. Thus, the functional element can be assembled in a particularly space-saving manner. The stiffening elements of the fuselage component are particularly suitable for accommodating electric lines such as, for example, electric supply lines, communication lines or signal lines and/or fluid lines such as, for example, air lines, oil lines or water lines of, for example, a communication system or an air conditioning system, since the stiffening elements define a continuous “tubing” network across the fuselage component. Connectors and/or plugs for connecting lines arranged in the internal cavities of the stiffening elements to each other and/or to a respective superordinate system may also be integrated into the internal cavities.

At least one opening may be provided in at least one of the stiffening elements of the fuselage component which provides access to the internal cavity of the stiffening element. The at least one opening may be used, for example, for inspecting the internal cavity. If need be, for example, a camera may be inserted through the opening and guided through the “tubing” network defined by the stiffening elements of the fuselage component so as to inspect the interior of the “tubing” network and/or functional elements arranged therein. Moreover, the opening may be used to replace functional elements arranged within the cavity of the stiffening element during maintenance

In a method of manufacturing a stiffened fuselage component which is particularly suitable for use in an aircraft, a skin element is provided. A plurality of elongated stiffening elements forming a stiffening element pattern comprising a plurality of node points are attached to an inner surface of the skin element, wherein at least some of the node points are defined by an intersection of at least two stiffening elements at an acute angle or an obtuse angle, and wherein at least some of the elongated stiffening elements are shaped so as to define an internal cavity delimited by an inner surface of the stiffening elements and covered by the skin element. The method may be suitably adapted to produce a preferred embodiment of the stiffened fuselage component as described above.

In the method of manufacturing a stiffened fuselage component, at least some of the plurality of elongated stiffening elements may be attached to the skin element in a curing step for curing a thermoset plastic material contained in at least one of the skin element and the plurality of elongated stiffening elements, i.e., at least some of the stiffening elements and the skin element may be joined to each other in a curing or a co-curing step. This allows a particularly efficient and time-saving manufacturing of high quality, high strength fuselage component. As an alternative, it is, however, also conceivable to manufacture, i.e., to shape and cure at least some of the plurality of elongated stiffening elements and the skin element separately and to attach the stiffening elements and the skin element to each other in a separate bonding step and/or by means of mechanical fastening devices, in particular rivets. This manufacturing option may be beneficial in terms of tooling costs and design flexibility. In any case, at least some of the plurality of integrated stiffening elements may be connected to each other by an internal skin element as described above.

At least some of the plurality of elongated stiffening elements, for curing a thermoset plastic material contained in the stiffening elements, may be arranged in respective depressions provided in a surface of a first tool. The surface of the first tool may be curved. During the curing step the stiffening elements may be maintained in place in the depressions provided in the surface of the first tool such that the stiffening elements are shaped as desired. The first tool may comprise a caul plate and the depressions for receiving the stiffening elements may be provided in the caul plate.

Similarly, the skin element, for curing a thermoset plastic material contained in the skin element, may be arranged on a surface of a second tool. During the curing step the skin element may be maintained in place on the surface of the second tool so as to shape the skin element as desired. For example, the second tool may be suitably designed so as to provide the skin element with a curved shape. If desired, the first and/or the second tool may be heated so as to promote the curing process.

At least one of the first tool and the second tool may comprise a plurality of tool cores. The tool cores may be detachably connected to each other, preferably by means of jigs. The tool cores of the first tool may be disassembled, i.e., detached from each other, in order to allow demolding of the stiffening elements from the first tool. In a similar manner, the tool cores of the second tool may be disassembled, i.e., detached from each other, in order to allow demolding of the skin element from the second tool. Providing at least one of the first and the second tool with detachably connected tool cores simplifies demolding of even a very large and very stiff component. This tool design thus is particularly advantageous, in case the fuselage component to be manufactured and hence the first and/or the second tool extend along a substantial part or along the entire circumference of a fuselage, in particular an aircraft fuselage, to be defined in part by the fuselage component. The fuselage to be produced then can be realized with a minimum number of joints.

A foam core, which may be designed as described above, may be arranged in the internal cavity of at least some of the elongated stiffening elements, in particular while the stiffening elements are arranged in the respective depressions provided in the surface of the first tool, before the internal cavity is covered by the skin element. The internal cavity may then be covered by the skin element by arranging the skin element on top of the stiffening elements while a thermoset plastic material contained in the skin element is still uncured, since the foam core stabilizes the skin element and hence provides for a shape stability of the skin element during the curing step. The stiffening elements and the skin element then may be co-cured in an efficient manner. As an alternative, it is, however, also conceivable to transfer the stiffening elements with their internal cavities filled with a foam core onto a skin element arranged on the surface of the second tool so as to cover the internal cavities of the stiffening elements with the skin element.

In a further preferred embodiment of the method for manufacturing a stiffened fuselage component, a film tube may be arranged in the internal cavity of at least some of the elongated stiffening elements, maintained in place during a curing step for curing a thermoset plastic material contained in the stiffening elements and removed before the internal cavity is covered by the skin element. The film tube may be effective so as to exert a pressure onto an inner surface of the internal cavities of the stiffening elements during the curing step as described in EP 2 662 202 A2 and US 2013/302544 A1. The film tube may be made of a material which has some flexibility to expand so as to simplify the built-up of pressure onto the inner surface of the internal cavities of the stiffening elements during the curing step.

The film tube may be pre-formed into a shape corresponding to the shape of the internal cavities of at least some of the stiffening elements and corresponding to the stiffening element pattern defined by the stiffening elements. In the region of the node points within the stiffening element pattern the film tube preferably is of a continuous design, i.e., in the region of the node points within the stiffening element pattern, the film tube may comprise a plurality of interconnected branches corresponding to the respective stiffening elements intersecting each other at the node points.

For pre-forming the film tube, a separate tool, which may be designed in the form of

a negative tool resembling the stiffening element pattern, may be used. For example, the film tube may be deep-drawn into the tool and joined by a melt-joining with an additional top layer film. Thereafter, the film tube may be cut out of the residual material so as to obtain a film tube resembling the stiffening element pattern. The film tube can be stored until it is needed. Prior to arranging the film tube in the internal cavity of at least some of the elongated stiffening elements, a vacuum can be used to reduce the size of the film tube and to thus simplify the integration of the film tube into the cavities of the stiffening elements.

An apparatus for manufacturing a stiffened fuselage component made of a fiber reinforced composite material, in particular for use in an aircraft, comprises a first tool having a surface provided with a plurality of depressions. The depressions are adapted to receive a plurality of elongated stiffening elements forming a stiffening element pattern comprising a plurality of node points, wherein at least some of the node points are defined by an intersection of at least two stiffening elements at an acute angle or an obtuse angle, and wherein the depressions are configured to shape at least some of the elongated stiffening elements in such a manner that they define an internal cavity delimited by an inner surface of the stiffening elements and adapted to be covered by a skin element.

The apparatus may further comprise a second tool having a surface adapted to support the skin element. At least one of the first tool and the second tool may comprise a plurality of tool cores which are adapted to be disassembled in order to allow demolding of the stiffening elements from the first tool and/or demolding of the skin element from the second tool.

Moreover, the apparatus may comprise a film tube adapted to be arranged in the internal cavity of at least some of the elongated stiffening elements, adapted to be maintained in place during a curing step for curing a thermoset plastic material contained in the stiffening elements and adapted to the removed before the internal cavity is covered by the skin element. The film tube may be pre-formed into a shape corresponding to the shape of the internal cavities of at least some of the stiffening elements and corresponding to the stiffening element pattern defined by the stiffening elements.

### BRIEF DESCRIPTION OF THE DRAWINGS

Preferred embodiments of the invention now are described in greater detail with reference to the appended schematic drawings, wherein

FIG. 1 shows a stiffened fuselage component which is adapted to define a section of an aircraft fuselage,

FIG. 2 shows an alternative stiffened fuselage component which is adapted to define a section of an aircraft fuselage,

FIG. 3 shows an exemplary method for manufacturing the stiffened fuselage component according to FIG. 1 or 2 using a first tool,

FIG. 4 shows a second tool which may be employed upon manufacturing the stiffened fuselage component according to FIG. 1 or 2, and

FIG. 5 shows a film tube which may be employed upon manufacturing the stiffened fuselage component according to FIG. 1 or 2.

### DETAILED DESCRIPTION OF THE PREFERRED EMBODIMENTS

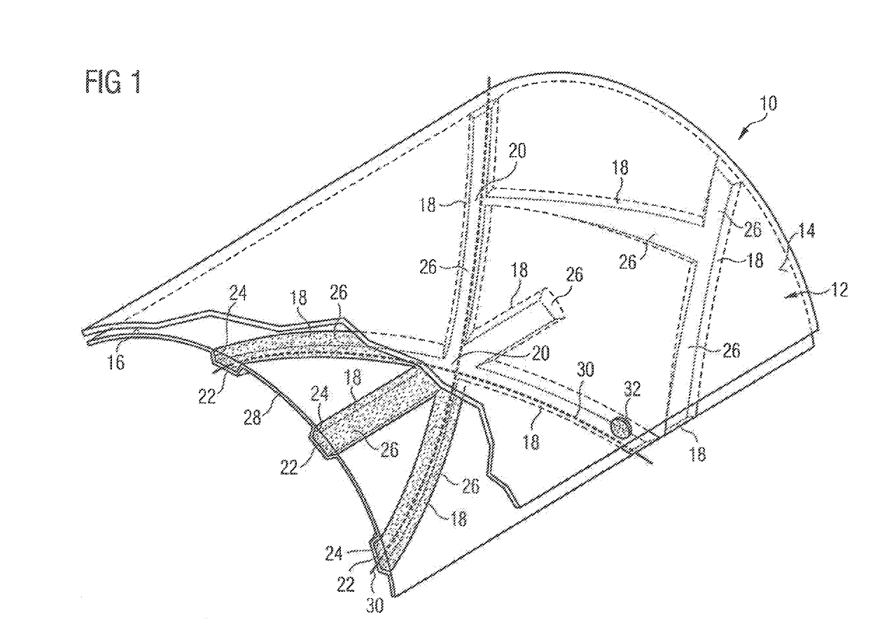

FIG. 1 shows a stiffened fuselage component 10 which is intended to define a section of the aircraft fuselage. The fuselage component 10 is made of a fiber reinforced composite material, in particular a carbon fiber reinforced composite material, wherein the carbon fibers are embedded within an epoxy resin matrix. It is, however, also conceivable to use other fiber reinforced composite materials for manufacturing the fuselage component 10.

The fuselage component 10 comprises a skin element 12 having a curved shape, wherein the curvature of the skin element 12 is adapted to the curvature of the aircraft fuselage intended to be defined with the aid of the fuselage component 10. An outer surface 14 of the skin element 12 is adapted to form an outer surface of an aircraft outer skin, whereas an inner surface 16 of the skin element is adapted to face an interior of the aircraft fuselage intended to be defined with the aid of the fuselage component 10.

For stiffening and reinforcing the skin element 12, the fuselage component 12 further comprises a plurality of elongated stiffening elements 18 which are attached to the inner surface 16 of the skin element 12. The stiffening elements 18 form a stiffening element pattern which comprises a plurality of node points 20. The node points 20 are defined by an intersection of at least two stiffening element 18 at an acute angle or an obtuse angle. In the exemplary embodiment of a fuselage component 10 depicted in FIG. 1, a first node point 20 is defined by an intersection of six stiffening elements 18, whereas second and third node points 20 are defined by an intersection of only three stiffening elements 18.

The stiffening element pattern defined by the stiffening elements 18 is an irregular pattern, wherein the distribution of the individual stiffening elements 18 within the stiffening element pattern is adjusted in dependence on load bearing requirements defined for different regions of the stiffened fuselage component 10. In the exemplary embodiment of a fuselage component 10 depicted in FIG. 1, the region around the first node point 20 which is defined by an intersection of six stiffening elements 18 distinguishes by a high “density” of stiffening elements 18 and hence high load bearing capacities. In contrast, regions of the fuselage component 10 extending between the stiffening elements 18 are less resistant to loads applied to the fuselage component 10 in use, but are more lightweight than the region around the first node point 20. The design of the fuselage component 10 thus can be locally optimized in terms of both load bearing capacities and weight.

In order to further optimize the load bearing capacities and the weight of the fuselage component 10, the stiffening elements 18 differ from each other in length, cross sectional shape and cross-sectional area. Furthermore, the elongated stiffening elements 18, along a longitudinal axis thereof, are provided with a varying cross sectional shape and a varying cross-sectional area. Furthermore, the integrated stiffening elements 18 are curved so as to extend parallel to the curved skin element 12. Moreover, the stiffening elements 18 are curved relative to a plane defined by the curved skin element 12, wherein the curvature of the stiffening elements 18 varies along the longitudinal axis.

Each of the stiffening elements 18 of the fuselage component 10 is shaped so as to define an internal cavity 22 which is delimited by an inner surface 24 off the stiffening elements 18. Furthermore, the internal cavity 22 of each stiffening element 18 is covered by the skin element 12 so as to define an enclosed hollow space. This allows a further optimization of the weight of the fuselage component 10. In the exemplary embodiment of a fuselage component 10 depicted in FIG. 1, the stiffening elements 18 are designed as omega stiffeners with an omega shape cross-section. Further, as becomes apparent from FIG. 1, foam cores 26 are arranged in the internal cavities 22 of the stiffening elements 18.

The fuselage component 10 further comprises an internal skin element 28 which connects the stiffening elements 18 to each other and which is made of the same material as the stiffening elements 18. The internal skin element 28 extends parallel to the skin element 12 and is attached to the skin element 12. The presence of the internal skin element simplifies attachment of the stiffening elements 18 to the skin element 28 as will be described further below.

Finally, the fuselage component 10 comprises functional elements in the form of electric lines 30 which is extend through the continuous “tubing” network defined by the internal cavities 22 of the stiffening elements 18. Thus, the electric lines 30 do not require additional installation space. An opening 32 which provides access to the “tubing” network defined by the internal cavities 22 of the stiffening elements 18 is present so as to allow inspection of the “tubing” network, for example by means of a camera, or replacement of the electric lines 30 during maintenance.

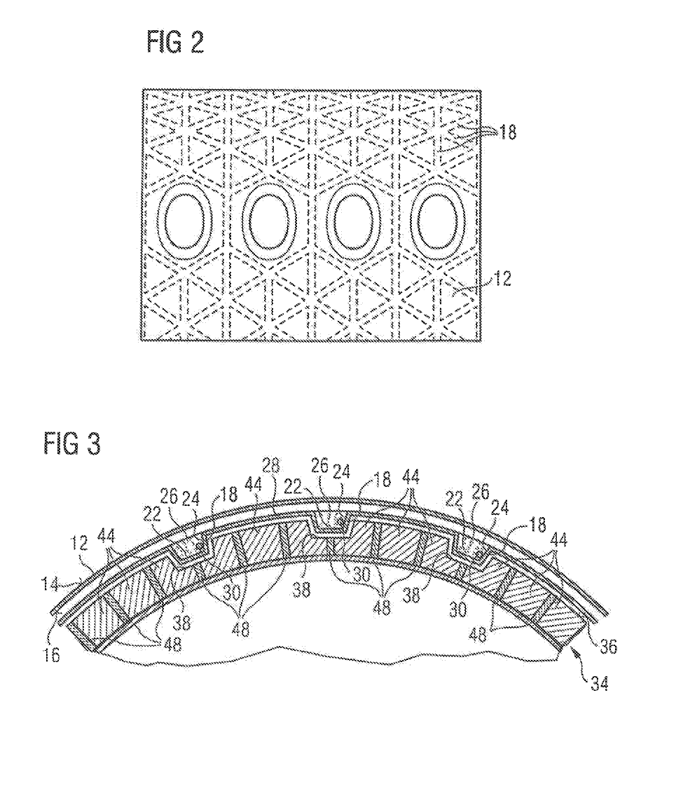

An alternative fuselage component 10 depicted in FIG. 2 which differs from the fuselage component 10 according to FIG. 1 in that the stiffening elements 18 of the fuselage component 10 define a regular Iso-grid pattern. Otherwise the structure of the fuselage component 10 according to FIG. 2 corresponds to the structure of the fuselage component 10 depicted in FIG. 1.

For manufacturing the fuselage component 10, a first tool 34 as depicted in FIG. 3 may be used. The first tool 34 comprises a surface 36 which is provided with a plurality of differently sized and shaped depressions 38, wherein each of the depressions 38 is adapted to receive one of the elongated stiffening elements 18 of the fuselage component 10, wherein the depressions 38 define a negative pattern of the positive stiffening element pattern defined by the stiffening elements 18. In particular, the depressions 38 resemble the stiffening element pattern comprising a plurality of node points 20, wherein at least some of the node points 20 are defined by an intersection of at least two stiffening elements 18 at an acute angle or an obtuse angle. Furthermore, the depressions 38 are configured to shape the stiffening elements 18 in such a manner that they define the internal cavity 22 delimited by the inner surface 24 of the stiffening elements 18 and adapted to be covered by the skin element 12.

The stiffening elements 18 with the thermoset plastic material contained therein still being uncured are arranged within the depressions 38 provided in the surface 36 of the first tool 34. In the arrangement of FIG. 3, the stiffening elements 18 are connected to each other by the internal skin element 28. However, the internal skin element 28 may also be omitted. Thereafter, the foam cores 26 are arranged within the internal cavities 22 of the stiffening elements 18. In a next step, the skin element 12 with the thermoset plastic material contained therein also still being uncured is arranged on top of the stiffening elements 18 and the foam cores 26. Finally, the thermoset plastic material contained in the stiffening elements 18, the internal skin element 28 and the skin element 12 is co-cured so as to attach the stiffening elements 18 and the internal skin element 28 to the skin element 12, while the foam cores 28 provide for the required stability of the skin element 12 during the curing process.

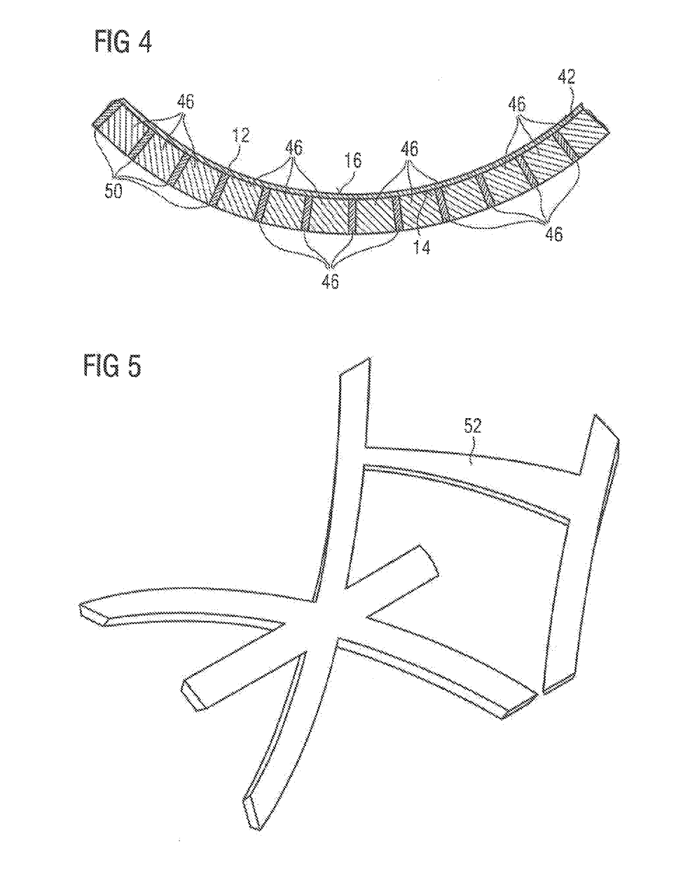

In an alternative manufacturing process, the thermoset plastic material contained in one of the skin element 12 and the stiffening elements 18 is at least partially cured prior to connecting the skin element 12 and the stiffening elements 18 to each other. For example, a second tool 40, which is depicted in FIG. 4, may be used for shaping the skin element 12 as desired. The second tool 40 comprises a curved surface 42 onto which the skin element 12 with the thermoset plastic material contained therein still being uncured is arranged. The curing of the thermoset plastic material contained in the skin element 12 then may be effected while the skin element 12 is supported on the surface 42 of the second tool 40.

As desired, the skin element 12 then may be demolded from the second tool 40 and laid onto the stiffening elements 18 arranged on the first tool 34 or the stiffening elements 18 may be demolded from the first tool 34 and transferred to the skin element 12 supported on the second tool 40. Each of the first and the second tool 34, 40 comprises a plurality of tool cores 44, 46 which are detachably connected to each other by means of jigs 48, 50. Thus, the tool cores 44 of the first tool 34 can be disassembled in order to allow easy demolding of the stiffening elements 18 from the first tool 34. Similarly, the tool cores 46 of the second tool 40 can be disassembled in order to allow easy demolding of the skin element 12 from the second tool 40.

The skin element 12 and the stiffening elements 18 then may be attached to each other by curing the still uncured thermoset plastic material contained in one of the skin element 12 and the stiffening elements 18. Further, it is also conceivable, to manufacture the skin element 12 and the stiffening elements 18 separately and then to attach the skin element 12 and the stiffening elements 18 to each other by bonding and/or by means of mechanical fastening devices such as, for example, rivets.

In an alternative method for manufacturing the stiffened fuselage component 10, a film tube 52 as depicted in FIG. 5 may be arranged in the internal cavities 22 of the elongated stiffening elements 18, maintained in place during a curing step for curing a thermoset plastic material contained in the stiffening elements 18 and removed before the internal cavity is covered by the skin element 12. The film tube 52 may be made of a material which has some flexibility to expand and may be effective so as to exert a pressure onto an inner surface of the internal cavities of the stiffening elements during the curing step as described in EP 2 662 202 A2 and US 2013/302544 A1.

The film tube 52 is pre-formed into a shape corresponding to the shape of the internal cavities 22 of the stiffening elements 18 and corresponding to the stiffening element pattern defined by the stiffening elements 18. In the region of the node points 20 within the stiffening element pattern, the film tube 52 is of a continuous design, i.e., in the region of the node points within the stiffening element pattern, the film tube 52 comprises a plurality of interconnected branches corresponding to the respective stiffening elements 18 intersecting each other at the node points 20. For pre-forming the film tube 52, a separate tool, which is designed in the form of a negative tool resembling the stiffening element pattern (not shown), is used.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A stiffened fuselage component made of a fiber reinforced composite material, comprising:
a skin element, and
a plurality of elongated stiffening elements forming a stiffening element pattern comprising a plurality of node points and being attached to an inner surface of the skin element,
wherein at least some of the node points are defined by an intersection of at least two stiffening elements at an acute angle or an obtuse angle, and
wherein at least some of the elongated stiffening elements are shaped so as to define an internal cavity delimited by an inner surface of the stiffening elements and covered by the skin element.

2. The stiffened fuselage component according to claim 1, wherein the stiffening element pattern is an irregular pattern, the distribution of the stiffening elements in the stiffening element pattern being adjusted in dependence on load bearing requirements defined for different regions of the stiffened fuselage component.

3. The stiffened fuselage component according to claim 1, wherein at least one of
at least some of the plurality of elongated stiffening elements differ from each other in at least one of length, cross sectional shape and cross-sectional area, and
at least some of the plurality of elongated stiffening elements, along a longitudinal axis thereof, are provided with at least one of
a varying cross sectional shape,
a varying cross-sectional area and
a curve with a constant or varying curvature.

4. The stiffened fuselage component according to claim 1, wherein at least some of the plurality of elongated stiffening elements comprise a foam core arranged in the internal cavity delimited by the inner surface of the stiffening elements and covered by the skin element.

5. The stiffened fuselage component according to claim 1, wherein at least one of
at least some of the plurality of elongated stiffening elements are connected to each other by an internal skin element extending substantially parallel to and being attached to the skin element,
at least one of an electric line and a fluid line is arranged in the internal cavity delimited by the inner surface of the stiffening elements and covered by the skin element, and
at least one opening is provided in at least one of the stiffening elements which provides access to the internal cavity of the stiffening element.

6. A method of manufacturing a stiffened fuselage component made of a fiber reinforced composite material, in particular for use in an aircraft, the method comprising:
providing a skin element, and
attaching a plurality of elongated stiffening elements forming a stiffening element pattern comprising a plurality of node points to an inner surface of the skin element,
wherein at least some of the node points are defined by an intersection of at least two stiffening elements at an acute angle or an obtuse angle, and
wherein at least some of the elongated stiffening elements are shaped so as to define an internal cavity delimited by an inner surface of the stiffening elements and covered by the skin element.

7. The method according to claim 6, wherein at least one of
at least some of the plurality of elongated stiffening elements, which are connected to each other by an internal skin element extending substantially parallel to the skin element, are attached to the skin element in a curing step for curing a thermoset plastic material contained in at least one of the skin element and the plurality of elongated stiffening elements, and
at least some of the plurality of elongated stiffening elements and the skin element are manufactured separately and attached to each other by at least one of bonding and mechanical fastening devices.

8. The method according to claim 6, wherein at least one of
some of the plurality of elongated stiffening elements, for curing a thermoset plastic material contained in the stiffening elements, are arranged in respective depressions provided in a surface of a first tool, and
the skin element, for curing a thermoset plastic material contained in the skin element, is arranged on a surface of a second tool.

9. The method according to claim 8, wherein at least one of the first tool and the second tool comprises a plurality of tool cores which are disassembled in order to allow at least one of
demolding of the stiffening elements from the first tool, and
demolding of the skin element from the second tool.

10. The method according to claim 6, wherein a foam core is arranged in the internal cavity of at least some of the elongated stiffening elements before the internal cavity is covered by the skin element.

11. The method according to claim 6, wherein a film tube is arranged in the internal cavity of at least some of the elongated stiffening elements, maintained in place during a curing step for curing a thermoset plastic material contained in the stiffening elements and removed before the internal cavity is covered by the skin element.

12. The method according to claim 11, wherein the film tube is pre-formed into a shape corresponding to the shape of the internal cavities of at least some of the stiffening elements and corresponding to the stiffening element pattern defined by the stiffening elements.

13. An apparatus for manufacturing a stiffened fuselage component made of a fiber reinforced composite material, the apparatus comprising:
a first tool having a surface provided with a plurality of depressions, the depressions being adapted to receive a plurality of elongated stiffening elements forming a stiffening element pattern comprising a plurality of node points,
wherein at least some of the node points are defined by an intersection of at least two stiffening elements at an acute angle or an obtuse angle, and
wherein the depressions are configured to shape at least some of the elongated stiffening elements in such a manner that they define an internal cavity delimited by an inner surface of the stiffening elements and adapted to be covered by a skin element.

14. The apparatus according to claim 13, further comprising a second tool having a surface adapted to support the skin element, wherein at least one of the first tool and the second tool comprises a plurality of tool cores which are configured to be disassembled in order to allow at least one of demolding of the stiffening elements from the first tool and demolding of the skin element from the second tool.

15. The apparatus according to claim 13, further comprising a film tube configured to be arranged in the internal cavity of at least some of the elongated stiffening elements, configured to be maintained in place during a curing step for curing a thermoset plastic material contained in the stiffening elements and configured to be removed before the internal cavity is covered by the skin element, the film tube being pre-formed into a shape corresponding to the shape of the internal cavities of at least some of the stiffening elements and corresponding to the stiffening element pattern defined by the stiffening elements.
